(19) United States
(12) Patent Application Publication
(10) Pub. No.: US 2014/0060714 A1
(43) Pub. Date: Mar. 6, 2014

(54) Protective Vehicle Cover

(71) Applicant: George A. Komperda, Medinah, IL (US)

(72) Inventor: George A. Komperda, Medinah, IL (US)

(21) Appl. No.: 13/604,584

(22) Filed: Sep. 5, 2012

(51) Int. Cl. B60J 11/00

(52) U.S. Cl. 150/166

(57) ABSTRACT

There is disclosed a protective vehicle cover, comprising of a water-proof canvas, a ply of foam, a ply of bubble-wrap, another water-proof canvas, and means of fastening; said foam and bubble-wrap are sewn in between, and together with two water-proof canvas. All materials are sewn together to compose the protective vehicle cover. The protective vehicle cover disclosed in present invention can be used for the protection of all kinds of vehicles, such as cars, trucks, boats, motorcycles, etc. The protective vehicle cover disclosed in present invention is light weighted, and easily rolled up for storage. Different designs and patterns to the water-proof canvas meet the needs of aesthetics.

### BACKGROUND OF THE INVENTION

### Field of the Invention

The present invention relates to protection of vehicles from damaging impact by hail or other falling objects. More particularly, the present invention relates to a protective vehicle cover which covers the outer surface of a vehicle for protecting said vehicle from impact damages by hail, falling objects, as well as from deleterious effects of natural elements such as sunlight and other environmental elements.

Large hailstones can reach high velocities and cause damages to vehicles. Most vehicle covers known prior arts, which use ordinary textiles for protection from typical outdoor weather conditions, such as sun, rain and snow, are incapable of resisting the impact of hail or falling objects.

There are some prior arts describing vehicle covers for protecting vehicles from hail or falling objects. Some prior arts disclose covers using air inflation crushing for protection.

For example, U.S. Pat. No. 5,890,525 discloses an inflatable car cover with a plurality of channel supported air pockets. Some prior arts disclose covers using foam rods to absorbing falling energy and to repel hail and falling objects.

For example, U.S. Pat. No. 5,664,825 to Henke et al. discloses a hail protective cover with a plurality of energy-absorbing rods disposed parallel and closely adjacent to one another.

U.S. Pat. No. 5,401,074 discloses a hail protective vehicle cover with several foam runners attached to a sheet of cloth. As stated in this patent's abstract, it is a vehicle cover that protects a vehicle from hail and other falling objects and is easily installed, removed, and stored in the trunk of the vehicle. The cover is substantially comprised of a sheet of cloth, several foam runners, and several attaching straps. The foam runners, preferably having a rectangular cross section, attach to the underside of the cloth. When placed on a vehicle, the foam runners support the cloth in a spaced apart relationship with the top of the vehicle. This however creates a type of trampoline so that the hail will bounce off of the protective sheet. Said invention discussed herein is able to use one uniform protective sheet coating to produce an even absorption of hail hitting the vehicle.

The above discussed prior arts may provide a certain degree of protection for vehicles from hail and falling objects, but there are some practical problems that remain unresolved.

For example, some of these prior art disclosures require excessive storage; some of them are inconvenience in application and removal; some of them lack the adequate protection that is needed for larger sized hail; and some of them lack a certain visual aesthetic to make it appealing for the user.

Therefore, there is a need for a protective vehicle cover which can provide adequate protection from large hail and falling objects, and at the same time the cover is light weighted, easy application and removal and is easily to meet aesthetic satisfactions.

### SUMMARY OF THE INVENTION

In an exemplary embodiment of the present invention, there is disclosed a protective vehicle cover, comprising of a water-proof canvas, a ply of foam, a ply of bubble-wrap, another water-proof canvas, and means of fastening; said foam and bubble-wrap are sewn in between, and together with two water-proof canvas. All materials are sewn together to compose the protective vehicle cover. Unique features include the uniform nature of the attachment of all layers of materials used.

The protective vehicle cover disclosed in present invention can be used for the protection of all kinds of vehicles, such as cars, trucks, boats, motorcycles, etc. The protective vehicle cover disclosed in present invention is light weighted, and easily rolled up for storage. Different designs and patterns to the water-proof canvas meet the needs of aesthetics.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a perspective picture of a boat having a protective vehicle cover installed.

FIG. 2 is a top and cross-sectional view of one embodiment of the protective vehicle cover.

FIG. 3 is a close up cross sectional view of one embodiment of the protective vehicle cover.

### DESCRIPTION OF THE PREFERRED EMBODIMENT

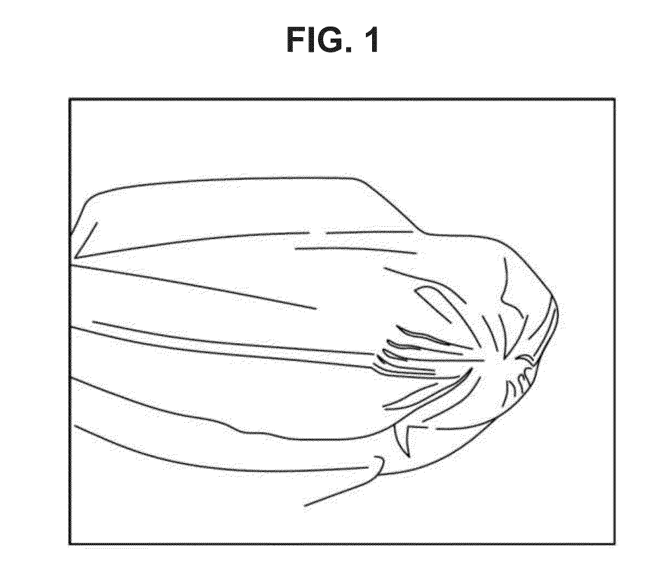

Referring to FIG. 1, there is disclosed a protective vehicle cover, which can be used to protect all types of vehicles, such as cars, trucks, boats, motorcycles and etc., from impact damages caused by hail and other falling objects, as well as from outdoor weather conditions, such as sun, rain and snow.

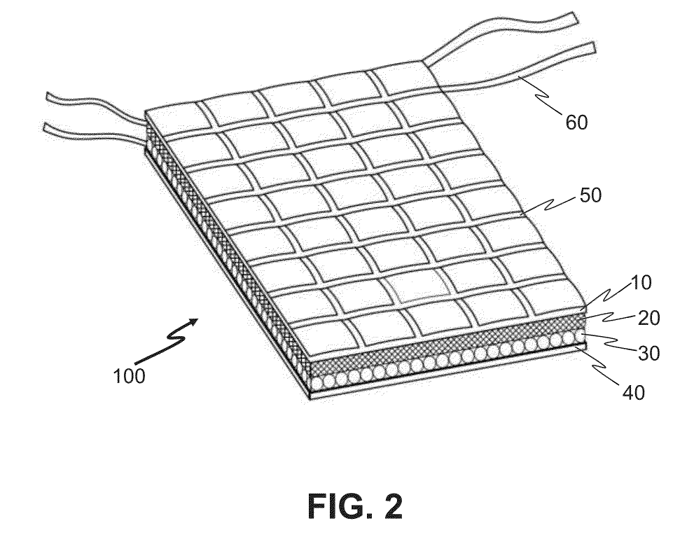

As illustrated in FIG. 2, one preferred embodiment of the present invention of protective vehicle cover 100 comprises of a water-proof canvas 10, a ply of foam 20, a ply of bubble-wrap 30, another water-proof canvas 50, and means of fastening 60. Said plies of foam 20 and bubble-wrap 30 are sewn in between and together with water-proof canvas 10 and 40. In another preferred embodiment of present invention of a protective vehicle cover, there is a checkered pattern 50 sewn all materials together as one to compose the protective vehicle cover.

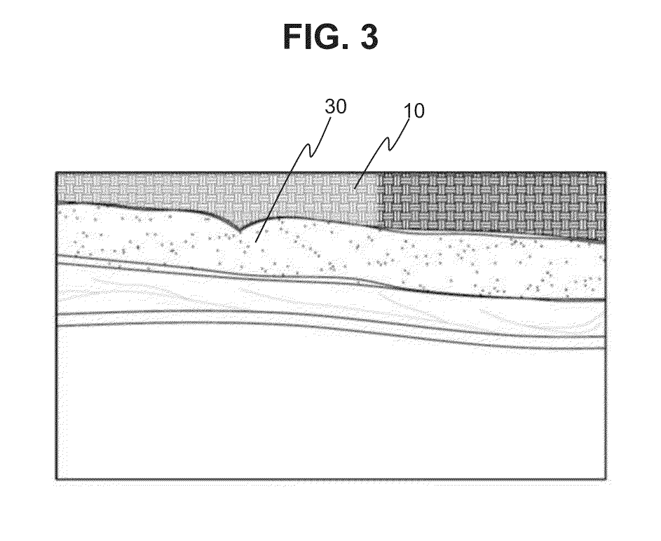

Referring to FIG. 3, an up close cross sectional presentation is seen. Herein, the canvas 10 is show as being directly attached to the bubble wrap 30 situated directly underneath said canvas.

In another embodiment of the present invention, the means of fastening 60 may be any commercially adequate fastening means, such as ropes, zippers and etc.

In another embodiment of the present invention, the foam 20 is a 1/16 strip foam and bubble-wrap 30 is heavy duty bubble-wrap strip.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings.

The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A protective vehicle cover comprising:
a) a water-proof canvas,
b) a ply of foam,
c) a ply of bubble-wrap,
d) another water-proof canvas, and
e) means of fastening;
wherein said foam and bubble-wrap are sewn in between, and together with said two water-proof canvas layers wherein each layer overlaps an equally sized and shaped prior layer.

2. A protective vehicle cover of claim 1, wherein said foam is 1/16 strip foam, and said bubble-wrap is a heavy duty bubble-wrap strip.

3. A protective vehicle cover of claim 2, wherein there shall be checkered patterns to sew all materials together as one to compose the protective vehicle cover.

4. protective vehicle cover of claim 3, wherein said means of fastening includes, but is not limited to, ropes and zippers.
